(19) United States
(12) Patent Application Publication
(10) Pub. No.: US 2005/0243048 A1
(43) Pub. Date: Nov. 3, 2005

(54) Display device, and electronic apparatus

(75) Inventors: Hidekuni Moriya, Suwa-shi (JP); Tsuyoshi Maeda, Kai (JP); Keiji Takizawa, Toyoshina-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/109,822

(22) Filed: Apr. 20, 2005

(30) Foreign Application Priority Data
Apr. 28, 2004 (JP) 2004-133493

(51) Int. Cl. G09G 3/36; G09G 5/02

(52) U.S. Cl. 345/88; 345/697; 345/102

(57) ABSTRACT

The present invention provides a display device and an electronic apparatus which are capable of realizing a remarkably wide range of color reproduction and displaying an image with display colors in a wide wavelength region which is similar to that of natural light and which are capable of minimizing the increased manufacturing cost caused by the increased number of coloring units in a unit pixel. The display device comprises a color filter unit which comprises a plurality of colored layers in a unit pixel, wherein the plurality of colored layers correspond to a plurality of wavelength regions with a wavelength selection characteristic; an illumination unit which illuminates illuminating light A onto the color filter unit, wherein the illuminating light comprises a spectral characteristic with peaks at a plurality of wavelength regions; and a transmitted light quantity control unit which controls the quantity of light which transmits the color filter unit, wherein the number of colored layers in the unit pixel is greater than the number of peaks at different wavelength regions of the illumination unit, and wherein image display is performed with the number of primary colors corresponding to the number of colored layers.

### BACKGROUND

The present invention relates to a display device and an electronic apparatus.

A conventional display device is constructed in such a way that three corresponding color dots of R(red), G(green), and B(blue) are provided in the unit pixel, in which the amount of light for each of the three color dots is changed to realize various colors, thereby performing an image display.

Also, the wavelength region of a color that cannot be displayed only by three colors of R/G/B existing in the natural world. Further, it is difficult to realize colors close to natural light.

In the prior arts, a color imaging system has been proposed in which it is possible to realize colors close to natural light (for example, see Patent Document 1). In the Patent Document 1, a color imaging system employs a pixel arrangement including R/G/B coloring units and a fourth coloring unit having a coloring characteristic in the wavelength range which falls in the negative red sensitivity portion. Since the fourth coloring unit corresponds to the color defined outside of the triangle region that connects each point of R/G/B on the chromaticity diagram, it could realize display colors in a wide wavelength region. The Patent Document 1 also discloses an image receiver having a color liquid crystal display, in which a plurality of sets of four coloring units corresponding to four sets of light emitting dots is arranged as a group.

[Patent Document 1] Japanese Unexamined Patent Application Publication No. 03-092888.

### SUMMARY

However, in the method disclosed in the above-mentioned patent document, although the display color in a wide wavelength region can be realized, the inventors of the present invention found that the manufacturing cost for a display device cannot be reduced because of the need to increase the number of fourth coloring units. That is, when using the above-mentioned technique, although the color reproducibility can be improved, it is not easy to commercialize the product due to the increased cost of the display device.

The present invention solves the above-mentioned problem and aims to provide a display device and an electronic apparatus which realizes a remarkably wide range of color reproduction, and displaying an image with display colors in a wide wavelength region which is similar to that of natural light, and which are capable to minimizing the increased manufacturing cost caused by the increased number of coloring units in a unit pixel.

The inventor of the present invention found that a backlight unit having four peak wavelengths is required in lighting four colors when the above-mentioned patent document was applied to an LCD (Liquid Crystal Display). And, in the arrangement of the backlight, it was also found that when a solid-state light source such as an LED is adopted, LEDs (Light Emitting Diode) for four separate colors are required and that when a fluorescent tube is adopted, four kinds of fluorescence material need to be applied in the tube, which led to an increase in the manufacturing cost for the backlight which is constructed in either the LED or the fluorescent tube. Furthermore, in the color characteristic design of the backlight, it was also found that adjusting the amount of current supplied to the solid-state light source of four colors and adjusting the mixture ratio in four kinds of fluorescence material were complicated.

In view of the above-mentioned problems, the inventor of the present invention has made the present invention as set forth below.

Namely, the display device according to the present invention comprises a color filter unit which has a plurality of colored layers in a unit pixel, in which the plurality of colored layers corresponds to a plurality of wavelength regions with a wavelength selection characteristic; an illumination unit for illuminating light onto the color filter unit, in which the illuminating light has a spectral characteristic with peaks at a plurality of wavelength regions; and a transmitted light quantity control unit for controlling the quantity of light transmitted to the color filter unit, wherein the number of colored layers in the unit pixel is greater than the number of peaks at different wavelength regions in the illuminating light illuminated by the illumination unit, and image display is performed with the number of primary colors corresponding to the number of colored layers.

In such a display device, the illumination unit illuminates illuminating light having a spectral characteristic with peaks at a plurality of wavelength regions onto the color filter unit. Moreover, the transmitted light quantity control unit controls the amount of light that transmitted to the color filter unit. By this arrangement, since an image display is performed with the number of primary colors corresponding to the number of colored layers and the quantity of light which transmits the colored layers is controlled by the transmitted light quantity control unit, the light transmitted to each of the colored layers is composed, and therefore it is possible to achieve a full color image display. Here, the number of colored layers which constitute the unit pixel of the color filter unit is greater than the number of peaks at different wavelength regions as spectral characteristic of the illuminating light.

Therefore, by providing a plurality of colored layers in a unit pixel, it is possible to realize a remarkably wide range of color reproduction and to display an image with display colors in a wide wavelength region which is similar to that of natural light. In addition, it is possible to realize a wide color range and to make the number of peaks at different wavelength regions in the illuminating light fewer than the number of colored layers in the unit pixel, thereby making it possible to simplify the components in the illumination unit. Further, the color characteristic design of the illumination unit can be easily adjusted as a result of having the simplified components in the illumination unit.

Moreover, in the above-mentioned display device, the number of colored layers in the unit pixel is four, the number of peaks at different wavelength regions in the illuminating light illuminated by the illumination unit is three, and image display is performed with four primary colors.

In this way, by providing four colored layers in the unit pixel, it is possible to realize a remarkably wide range of color reproduction and to display an image with display colors in a wide wavelength region which is similar to that of natural light. In addition to realizing a wide color range, it is possible to make the number of peaks at different wavelength regions in the illuminating light to be three, thereby making it possible to simplify the components in the illumination unit. Further, the color characteristic design of the illumination unit can be easily adjusted as a result of having the simplified components in the illumination unit.

Moreover, the above-mentioned display device is characterized in that two peak wavelengths in the wavelength selection characteristic of the two colored layers correspond to the two peak wavelengths as the spectral characteristic of the illuminating light, respectively.

In this way, since the peak wavelength of two pieces corresponds to each other because of the wavelength selection characteristic of the colored layer and the spectral characteristic of illuminating light, the color with the corresponding peak wavelength can be displayed with a clear color.

In the present invention, the expression that “the wavelengths corresponds to each other” does not mean that they match each other completely in an optical design, but means that the wavelengths closely match with each other or that the wavelengths are set to match with each other.

Moreover, the above-mentioned display device is characterized in that the two peak wavelengths are peak wavelengths which are respectively located at the longer wavelength side and the shorter wavelength side in the visible light wavelength region.

With this arrangement, according to the wavelength selection characteristic of a colored layer and the spectral characteristic of illuminating light, the peak wavelength that shows the R display color and the peak wavelength that shows the B display color correspond to each other. Therefore, since the illuminating light which has the wavelengths of R and B is not absorbed or attenuated in the colored layer, it is possible to display R and B with a clear coloring.

Moreover, the other two peak wavelengths in the four colored layers (peak wavelengths except for R and B) and one remaining peak wavelength (a peak wavelength except for R and B) in the illuminating light are located at the wavelength region between the longer wavelength side and the shorter wavelength side. Specifically, the peak wavelengths that show the Y (yellow), G and C (cyan) display colors are located between the peak wavelengths of R and B. Here, since G or a color having a wavelength closer to that of G is a color of comparatively high visual-sensitivity as compared to R or B and the wavelength of R and B can be displayed with a clear coloring, it is possible to perform a full color image display with a clear coloring by coloring four colors of the colored layers as a whole.

Moreover, the above-mentioned display device is characterized in that the peak wavelengths of the illuminating light are located in three regions of 400 to 490 nm, 490 to 570 nm, and 600 nm or more in accordance with the spectral characteristic, and the colored layer in the unit pixel has the wavelength selection characteristic which includes four regions of 400 to 490 nm, 490 to 520 nm, 520 to 570 nm, and 600 nm or more.

In this way, since the peak wavelength as the spectral characteristic of the illuminating light corresponds to the wavelength selection characteristic of a colored layer, specifically in the wavelength region of 400 to 490 nm and the wavelength region of 600 nm or more, it is possible to display R and B with a clear coloring.

In addition, since the peak wavelength of illuminating light corresponds to the wavelength selection characteristic of a colored layer, specifically in the wavelength region of 490 to 520 nm and 520 to 570 nm in the wavelength selection characteristic of the colored layer and the 490 to 570 nm wavelength region as the spectral characteristic of the illuminating light, it is possible to display G and C with a clear coloring. Therefore, it is possible to display each colors of R, G, B, and C with a clear coloring and thus to perform a full color image display with a clear coloring.

Moreover, since four colored layers in the unit pixel correspond to R, G, B, and C, it is possible to realize a remarkably wide range of colors and thus to realize display colors in a wide wavelength region which is similar to that of natural light.

To explain in detail, since in xy chromaticity characteristic, the region defined by the left or the upper left side of the line connecting the coordinates of B and G is larger than the region defined by the upper right side of the line connecting the coordinates of G and R and the region defined by the lower right side of line connecting the coordinates of G and B, the region defined by the left or the upper left side of the line connecting the coordinates of B and G is a region where the possibility of expressing colors close to natural light is greater. Here, since the colored layer having a color coordinate located at the region defined by the left or the upper left side of the line connecting the coordinates of B and G, that is the colored layer of C, is provided in the unit pixel, it is possible to widen the color reproduction range in the above-mentioned greater region where the possibility of expressing colors close to natural light is greater. Therefore, it is possible to realize a remarkably wide range of color reproduction and thus to realize the display color in a wide wavelength region which is similar to that of near natural light.

Further, a display device having four color dots containing C in a unit pixel can widen the range of a region that can be displayed in the xy chromaticity characteristic as compared to the display device having other color dots, such as a dot of Y, in the unit pixel.

Moreover, the above-mentioned display device is characterized in that the illumination unit illuminates the illuminating light on the color filter by using a fluorescent tube.

In the illumination unit using the fluorescent tube, since it is not necessary to apply four kinds of fluorescence material in the fluorescent tube and the illumination unit is constructed by applying three kinds of fluorescence material (RGB) in the tube, as compared to the case where four kinds of fluorescence material is applied, the fluorescent tube can be formed in a simple arrangement and the rise in manufacturing cost of the illumination unit can be minimized. Moreover, the color adjustment can easily be performed when designing the color characteristic of the illumination unit.

In this way, it is therefore possible to realize a remarkably wide range of color reproduction, and to display an image with display color in a wide wavelength region which is similar to that of natural light, and thus to minimize the rise in manufacturing cost of the illumination unit.

Moreover, the above-mentioned display device is characterized in that the illumination unit illuminates the illuminating light on the color filter by using a solid-state light source.

Here, the solid-state light source means the light source having spontaneous light emitting devices, such as LED, OLED (organic electroluminescence device), and FED (field emitting device).

In the illumination unit using the solid-state light source, since it is not necessary to use four kinds of solid-state light sources to emit respective lights of four colors and the illumination unit is constituted by three kinds of solid-state light sources (RGB), as compared to the case where four kinds of solid-state light sources are used, the arrangement thereof becomes simple and the rise in manufacturing cost of the illumination unit can be minimized. Moreover, the color adjustment can be easily performed when designing the color characteristic of the illumination unit.

In this manner, it is therefore possible to realize a remarkably wide range of color reproduction, and to display an image with near natural light color of wide wavelength region and thus to minimize the rise in manufacturing cost of the illumination unit.

In addition, the spectral characteristic of the illumination unit using the solid-state light source shows a smoother distribution as compared to the case where the fluorescent tube is used in the illumination unit. By this, the spectral characteristic of the transmitted light, which has transmitted through the colored layer of the color filter unit, shows a smooth distribution as well. Therefore, it is possible to display with a spectral characteristic that shows the above-mentioned smooth distribution.

Moreover, in the illumination unit using the solid-state light source, it is possible to easily adjust the color characteristic design as compared to the illumination unit using the fluorescent tube.

Specifically, in order to use the fluorescent tube as the illumination unit, it is necessary to manufacture a fluorescent tube by applying a fluorescence material corresponding to the luminescence color onto the tube and to check whether or not the illuminating light having a desired spectral characteristic is obtained, and to use the fluorescent tube as the illumination unit. Therefore, after the fluorescent tube has been manufactured, it is not possible to adjust the spectral characteristic of the fluorescent tube.

On the other hand, in case of using a solid-state light source as the illumination unit, since it is checked whether or not the illuminating light having a desired spectral characteristic is obtained while adjusting the amount of current supplied to the solid-state light source of RGB corresponding to the and the solid-state light source is used as the illumination unit, it is possible to arbitrarily adjust the spectral characteristic.

Therefore, in the illumination unit using the solid-state light source, it is possible to easily performed the color characteristic design as compared to the illumination unit using the fluorescent tube.

In addition, an electronic apparatus according to the present invention is characterized in that it comprises the display device as described above.

As the electronic apparatus, an information processing equipment, such as a portable telephone, a mobile information terminal, a watch, a word processor, and a personal computer, etc. can be exemplified, along with a television equipped with a large display screen and a large size monitor, etc. By providing the display device according to the present invention in these electronic apparatuses, it is possible to display an image with display colors in a wide wavelength region which is similar to that of natural light and to provide an electronic apparatus at a low cost.

### BRIEF DESCRIPTION OF THE DRAWINGS

FIG. 1 is a block diagram showing an arrangement of an image display system according to first embodiment of the present invention;

FIG. 2 is a top plan view showing each components of a liquid crystal panel in the image display system of FIG. 1;

FIG. 3 is a perspective view showing a cross-sectional arrangement of the liquid crystal panel in the image display system of FIG. 1;

FIG. 4 is a top plan view showing an arrangement of a color filter of the liquid crystal panel in the image display system of FIG. 1;

FIGS. 5A-5D show various optical characteristics of the image display system according to the first embodiment of the present invention;

FIGS. 6A-6D show various optical characteristics of an image display system according to second embodiment of the present invention; and

FIG. 7 shows an electronic apparatus equipped with the display device of the present invention.

### DETAILED DESCRIPTION OF EMBODIMENTS

Hereafter, embodiments of the present invention will be described with reference to the drawings.

In drawings below, each layer and each component may be depicted with a different size in order to make the layers and components readily recognizable in the drawings.

(First Embodiment)

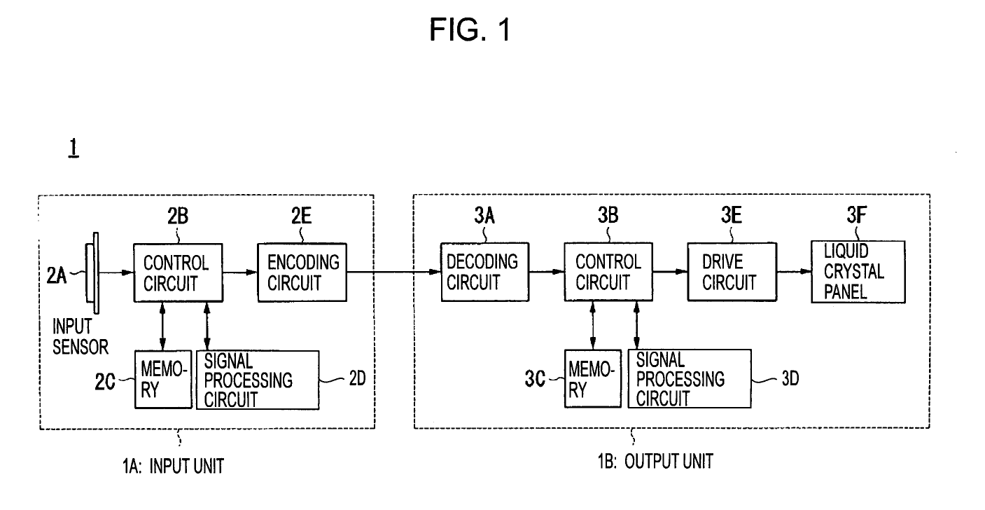

Hereinafter, a first embodiment of the present embodiment will be described with reference to the FIGS. 1 to FIG. 5.

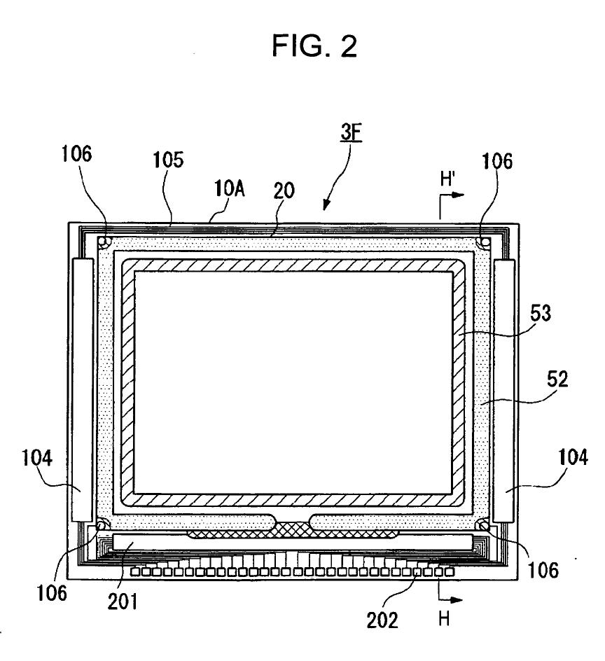

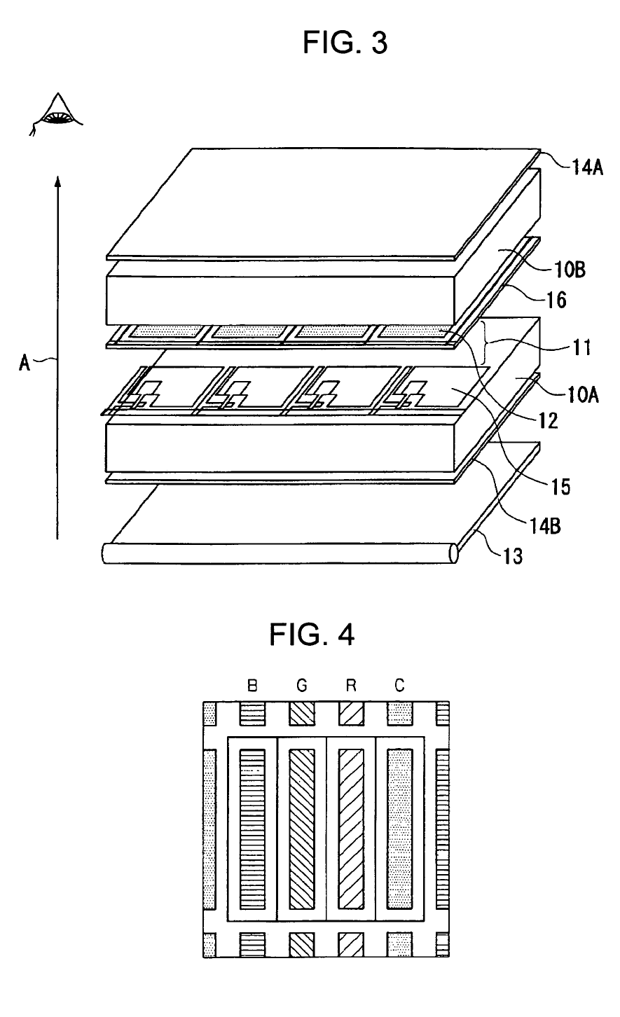

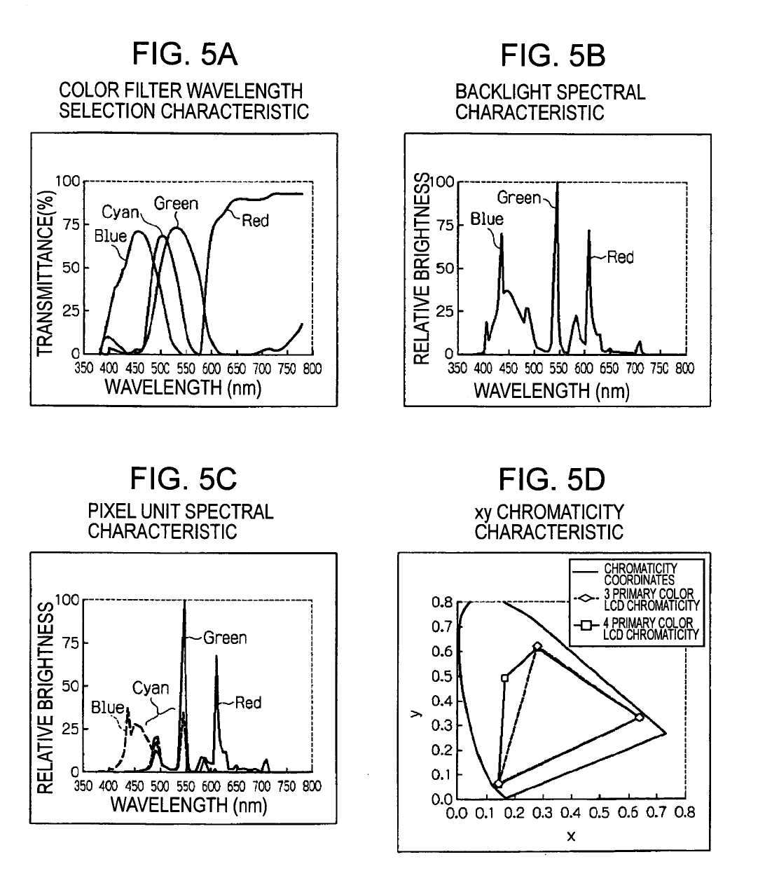

FIG. 1 is the block diagram showing an arrangement of an image display system according to the first embodiment. FIG. 2 is a top plan view showing each component of a liquid crystal panel in the image display system, which is viewed from an opposing substrate side. FIG. 3 is a perspective view illustrating a cross-sectional arrangement of the liquid crystal panel. FIG. 4 is a top plan view showing an arrangement of a color filter of the liquid crystal panel. FIG. 5 depicts a color filter wavelength selection characteristic, a backlight spectral characteristic, a pixel unit spectral characteristic and an xy chromaticity characteristic of the liquid crystal panel.

As shown in FIG. 1, the image display system 1 is constituted by an input unit 1A and an output unit 1B.

Furthermore, the input unit 1A is equipped with an input sensor 2A, a control circuit 2B, a memory 2C, a signal processing circuit 2D, and an encoding circuit 2E.

Moreover, the output unit 1B is equipped with a decoding circuit 3A, a control circuit 3B, a memory 3C, a signal processing circuit 3D, a drive circuit 3E, and a liquid crystal panel 3F.

Here, in the input unit 1A, an image data is inputted by photoelectric conversion from an input sensor 2A. Moreover, the image data is processed by a signal processing circuit 2D via a control circuit 2B, and is encoded in the encoding circuit 2E. On the other hand, in the output unit 11B, the image data processed in the encoding circuit 2E is decoded in the decoding circuit 3A. Furthermore, after being processed by a signal processing circuit 3D via a control circuit 3B, it is changed into a drive signal in the drive circuit 3E, and supplied to the liquid crystal panel 3F. In addition, the data of the control circuits 2B and 3B is suitably stored in the memory 2C and 3C.

Moreover, as will be described later, the image display system 1 performs the color reproduction with four primary colors in the liquid crystal panel 3F. Therefore, a signal processing circuit 3D of the output unit 1B shown in FIG. 1 changes the inputted image data of three primary colors into the image data of four primary colors. Specifically, if image data is inputted and transmitted as an ordinary three primary color signal, the image data is converted from the three primary color data to four primary color data in a signal processing circuit 3D. In such a conversion of the number of primary colors, it is converted by the table lookup method automatically referring a predetermined conversion table where the three primary color data is converted to four primary color data.

In the liquid crystal panel (display device) 3F as shown in FIG. 2, a liquid crystal layer 11 is enclosed in the region where TFT array substrate 10A and opposite substrate 10B are stuck together with a seal material 52 therebetween, and are divided by the seal material 52. A light shielding film (circumference break line) 53 made of light blocking nature material is formed in the inner side of the region where the seal material 52 is formed. In the circumference circuit region at the outer side of the seal material 52, the data line drive circuit 201 and the external circuit mounting terminal 202 are formed along one side of TFT array substrate 10A, and the scanning line drive circuits 104 are formed along the two sides adjacent to the one side of the TFT array substrate 10A. A plurality of wiring lines 105 for connecting the scanning line drive circuits 104 formed at the both sides of the display region are formed in the remaining one side of the TFT array substrate 10A. Moreover, the inter-substrate conducting material 106 for electrically connecting the TFT array substrate 10A and the opposite substrate 20 is disposed in the angle part of opposite substrate 10B.

Therefore, the liquid crystal panel 3F is the transmission type liquid crystal panel of the active matrix type that uses TFT (Thin Film Transistor; hereinafter will be shortened as TFT) as a switching element.

Moreover, as shown in FIG. 3, a pixel electrode 15 is formed at inner side of the TFT array substrate 10A, and a common electrode 16 is formed at inner side of the opposite substrate 10B. Furthermore, the color filter 12 is formed between the opposite substrate 10B and the common electrode 16.

Moreover, a backlight unit 13 and upper and lower polarizing plates 14A and 14B are formed in the outer sides of the TFT array substrate 10A and the opposite substrate 10B.

In addition, in the first embodiment, the term “inner side” means the side where the liquid crystal layer 11 is formed, and the term “outside” means the side where the liquid crystal layer 11 is not located.

Now, each component will be explained below.

The TFT array substrate 10A and the opposite substrate 10B are formed by transparent substrate, such as a glass plastic substrate.

Moreover, the pixel electrode 15 and the common electrode 16 are formed with transparent conductive objects, such as ITO (Indium Tin Oxide). Furthermore, the pixel electrode 15 is connected with a TFT (Thin Film Transistor) circuit, not shown in figure, which is provided at the TFT array substrate 10A, and the pixel electrode 15 applies a voltage to the liquid crystal layer 11 which is located between the common electrode 16 and the pixel electrode 15 in response to the switching drive of the TFT.

The liquid crystal layer 11 comprises a liquid crystal molecule whose arrangement is changed according to the voltage value applied from the common electrode 16 and the pixel electrode 15. In the first embodiment, TN (Twisted Nematic) mode having 90 degrees twisted angle between the TFT array substrate 10A and the opposite substrate 10B is adopted as the liquid crystal mode.

Moreover, the upper and lower polarizing plates 14A and 14B are arranged so that the transmission axes of the upper and lower polarizing plates 14A and 14B intersect perpendicularly each other.

In such a liquid crystal layer 11 and the upper and lower polarizing plates 14A and 14B, since the arrangement of liquid crystal molecules changes according to the voltage value given to the liquid crystal layer 11, the quantity of lights which transmits the liquid crystal layer 11 and the upper and lower polarizing plates 14A and 14B changes. Therefore, the liquid crystal layer 11 functions as a transmitted light quantity control unit of the present invention, and controls the quantity of lights (illuminating light) that is incident from the backlight unit 13 side. Thus, predetermined quantities of lights are transmitted to an observer side.

In addition, as the liquid crystal mode of the liquid crystal layer 11, it is not limited to TN mode. For example, STN (Super Twisted Nematic) mode, VA (Vertical Aligned) mode, IPS (In-Plain Switching) mode, etc. may also be adopted. Moreover, in the first embodiment, as a switching element that gives voltage to the liquid crystal 11, it is not limited to TFT. For example, TFD (Thin Film Diode) may also be adopted. Besides an active element like TFT or TFD, a passive element may also be adopted.

Next, an explanation will be given to the arrangement of the color filter 12.

FIG. 4 shows the color filter 12 in which one pixel is constituted by four colored layers and shows the pixel arrangement that consists of colored layers of four colors made by adding a colored layer of C to the colored layers of RGB three colors. Therefore, by illuminating the illuminating light of the backlight unit 13 onto the each colored layer of BGRC, light in a predetermined wavelength region contained in the illuminating light, that is light of predetermined color, is transmitted to an observer side. Moreover, the color filter 12 having such arrangement will be placed all over the display region in the liquid crystal panel 3F as shown in FIG. 2.

FIG. 5(a) shows the wavelength selection characteristic of the color filter 12. As shown in FIG. 5(a), the wavelength selection characteristic of a colored layer of four colors of B (Blue), C (Cyan), G (Green), and R (Red) is distributed in this order from the shorter wavelength side of visible light towards a longer wavelength side. Therefore, the color filter 12 selectively transmits the illuminating light of the backlight unit 13 so that only the illuminating light at the four peak wavelengths can be transmitted.

In addition, a well-known method can be adopted for the method of manufacturing the color filter 12. For example, a method in which a resist is formed by using photolithography method is exposed and developed, and then the colored layer of B, C, G, and R are formed may also be applied. Moreover, a discharge formation method may also be applied in which the materials of B, C, G and R are discharged from the discharge head filled with various liquid material in a predetermined pattern by using the ink jet method. Moreover, a method of forming the color filter 12 by dyeing each of B, C, G and R may also be applied.

Moreover, when arranging four colors of BGRC in a stripe type, a flexibility can be occurred in the order of the color arrangement (in case of three colors, no matter how the colors may be arranged in order, flexibility can not be found due to the periodicity and symmetry). Although FIG. 4 shows an exemplary arrangement in order of BGRC from the left, besides this order, another order of arrangement such as BCGR can be contemplated. However, in relation to the spectral characteristic, since it is taken from a macroscopic viewpoint, it is not necessary to take the arrangement order of a pixel into consideration. Moreover, it is possible to arrange BGRC in a unit pixel by not only stripe type arrangement but also delta type arrangement and mosaic arrangement.

Next, an explanation will be given to the arrangement of the backlight unit 13.

The backlight unit 13 functions as an illumination unit of the present invention, and is constituted by a light source and a light guiding plate. In such arrangement, the light, which is emitted from the light source, is uniformly spread and is outputted into the light guiding plate in the direction A. The light source is a fluorescent tube and a plurality of kinds of fluorescence materials are applied in the fluorescent tube. Moreover, by adjusting the mixture ratio of fluorescence materials, a desired spectral characteristic can be acquired. Moreover, the light guiding plate consists of resin such as acryl.

The liquid crystal panel 3F having such arrangement is a transmission type liquid crystal panel in which the lights emitted from the backlight unit 13 is illuminated towards the direction A and is taken out from the opposite substrate 10B side. Therefore, the display of a liquid crystal is performed using the source light of the backlight unit 13. FIG. 5(b) shows the spectral characteristic of the backlight unit 13. As shown in FIG. 5(b), the spectral characteristic of the illuminating light emitted from the backlight unit 13 is distributed in order of B (Blue), G (Green), and R (Red) towards the longer wavelength side from the shorter wavelength side of visible light. In this way, the number of the peak wavelengths in the illuminating light of the backlight unit 13 is three that is fewer than four, that is, the number of the peak wavelengths in the wavelength selection characteristic of the color filter 12.

Furthermore, as shown in Table 1, in the spectral characteristic (refer to (b) in Table 1) of the illuminating light in the backlight unit 13, the peak wavelength in the characteristic are located in three regions of 400 to 490 nm, 490 to 570 nm and 600 nm or more. Moreover, the wavelength selection characteristic (refer to (a) in Table 1) of the color filter 12 is located in four regions of 400 to 490 nm, 490 to 520 nm, 520 to 570 nm, and 600 nm or more.

Here, the 400 to 490 nm region and 600 nm or more region correspond to wavelengths that show B and R respectively and to the shorter wavelength side of visible light and longer wavelength side of visible light. In the 400 to 490 mn region and the 600 nm or more region, the spectral characteristic of the illuminating light of the backlight unit 13 and the wavelength selection characteristic of a colored layer match each other.

Furthermore, in the wavelength selection characteristic of a colored layer, the 490 to 520 nim region and the 520 to 570 nm region serve as wavelengths that show C and G Moreover, in the spectral characteristic of the illuminating light of the backlight unit 13, the 490 to 570 nm region serves as wavelength that shows the color of G. Thus, C and G of the colored layer are displayed by the light of the wavelength that shows G contained in illuminating light.

Moreover, the 520 to 570 nm region (G) in the wavelength selection characteristic of the colored layer and the 490 to 570 nm region (G) in the spectral characteristic of illuminating light is set such that they may be in agreement in general. Moreover, as for the 490 to 520 nm region (C) in the wavelength selection characteristic of the colored layer, this region (C) is not need to be set to match with the peak wavelength of the spectral characteristic of the illuminating light.

TABLE 1

| (a) | | (b) | |
|---|---|---|---|
| COLOR | PEAK WAVELENGTH | COLOR | PEAK WAVELENGTH |
| Blue | 400 to 490 nm | Blue | 400 to 490 nm |
| Cyan | 490 to 520 nm | Green | 490 to 570 nm |
| Green | 520 to 570 nm | | |
| Red | 600 nm or more | Red | 600 nm or more |

| | |
|---|---|
| COLOR FILTER SPECTRAL | BACKLIGHT SPECTRAL |
| CHARACTERISTIC | CHARACTERISTIC |
| PEAK WAVELENGTH RANGE | PEAK WAVELENGTH RANGE |

The image display system 1 having such arrangement, the image data inputted into the input sensor 2A is outputted to the liquid crystal panel 3F through the control circuit 2B and 3B, the signal processing circuits 2D and 3D, the encoding circuit 2E, the decoding circuit 3A, and the drive circuit 3E.

Specifically, in the liquid crystal panel 3F, the illuminating light of the backlight unit 13 illuminates a colored layer of four colors of the color filter 12. Here, the wavelengths according to the spectral characteristic mentioned above are contained in the illuminating light. Moreover, the colored layer transmits the colors of the wavelengths according to the above-mentioned wavelength selection characteristic. Moreover, the liquid crystal layer 11 controls the quantity of lights transmitting the color filter 12. By this construction, an image is displayed with four primary colors of BCGR of the colored layer in a unit pixel as shown in FIG. 5(c). Further, since the quantity of lights that transmit each colored layer is controlled by the liquid crystal layer 11, the lights that transmitted each of the colored layers are composed and therefore it is possible to achieve a full color image display.

Next, as shown in FIG. 5(c), the spectral characteristic of the colored layer of C becomes to show a-distribution where both of the spectral characteristics of B and G of the illuminating light of the backlight unit 13 are contained. Therefore, although a single characteristic peak value of C was appeared in the spectral characteristic in the prior art document, the single characteristic peak value of C was not appeared in the first embodiment.

Next, with reference to FIG. 5(d), a xy chromaticity characteristic in which the liquid crystal panel having the colored layer of four colors (4CF) in a unit pixel as mentioned above is compared to the liquid crystal panel having the colored layer of three colors (3CF) of RGB will be described. Although it is possible to realize the color of the triangle region in xy chromaticity characteristic with the pixel arrangement of three color colored layer, it is possible to realize the color of the quadrangle region in xy chromaticity characteristic with the pixel arrangement of four color colored layer. Therefore, the liquid crystal panel 3F of the first embodiment having the pixel arrangement of the colored layer of four colors are able to realize a wide color range.

As mentioned above, in the first embodiment, the number of the colored layers which constitute the unit pixel of the color filter 12 is made to be greater than the number of peaks at different wavelength regions of spectral characteristic that are in the illuminating light. That is, the number of colored layers in the unit pixel is four, the number of peaks at different wavelength regions in the illuminating light in the spectral characteristic is three, and image display is performed with four primary colors.

As a result, by providing four colored layers in the unit pixel, it is possible to realize a remarkably wide range of color reproduction and to display an image with display colors in a wide wavelength region which is similar to that of natural light. In addition to realizing a wide color range, it is possible to make the number of peaks at different wavelength regions in the illuminating light fewer than the number of the colored layers in the unit pixel, thereby making it possible to simplify the components in the backlight unit 13. Furthermore, the color characteristic design of the backlight unit 13 can be easily adjusted as a result of having the simplified components in the backlight unit 13.

Moreover, since the peak wavelengths in the wavelength selection characteristic of R and B in the colored layers correspond to the peak wavelength of the spectral characteristic of R and B contained in illuminating light, the illuminating light which has the wavelengths of R and B is not absorbed or attenuated in the colored layers, and thus it is possible to display R and B with a clear coloring.

Moreover, with this arrangement, the wavelength selection characteristics of C and G in the colored layers and the spectral characteristic of G in the illuminating light will be located within the wavelength region of R and B. G and C are colors of comparatively high visual-sensitivity as compared to R or B. Since R and B can be displayed with a clear coloring, it is possible to perform a full color image display with a clear coloring by coloring four colors of the colored layers as a whole.

Moreover, since the peak wavelengths of the illuminating light are located in three regions of 400 to 490 nm, 490 to 570 nm, and 600 nm or more in accordance with the spectral characteristic, and the colored layers in the unit pixel have the wavelength selection characteristic which consists of four regions of 400 to 490 nm, 490 to 520 nm, 520 to 570 nm, and 600 nm or more, the peak wavelengths in the spectral characteristic of the illuminating light correspond to the wavelength selection characteristics of the colored layers, and it is possible to display R and B with a clear coloring.

In addition, since the peak wavelengths of the illuminating light correspond to the wavelength selection characteristics of the colored layers, specifically in the wavelength regions of 490 to 520 nm and 520 to 570 nm in the wavelength selection characteristics of the colored layers and the 490 to 570 nm wavelength region in the spectral characteristic of the illuminating light, it is possible to display the color of G and C with a clear color. Therefore, it is possible to display each colors of R, G, B, and C with a clear coloring and thus to perform a full color image display with a clear coloring.

Moreover, since four colored layers in a unit pixel correspond to R, G, B, and C, it is possible to realize a remarkably wide range of color reproduction and thus to realize display colors in a wide wavelength region which is similar to that of natural light.

To explain in detail, since in xy chromaticity characteristic, the region defined by the left or the upper left side of the line connecting the coordinates of B and G is larger than the region defined by the upper right side of the line connecting the coordinates of G and R and the region defined by the lower right side of the line connecting the coordinates of R and B, the region defined by the left or the upper left side of the line connecting the coordinates of B and G is a region where the possibility for expressing colors close to natural light is greater. Here, since the colored layer having a coordinate located at the region defined by the left or the upper left side of the line connecting the coordinates of B and G, that is the colored layer of C, is provided in the unit pixel, it is possible to widen the color reproduction range in the above-mentioned greater possibility region. Therefore, it is possible to realize a remarkably wide range of color reproduction and thus to realize display colors in a wide wavelength region which is similar to that of natural light.

Further, the liquid crystal panel 3F in which the colored layers of four colors containing C is provided in the unit pixel can widen the range of a region that can be displayed in the xy chromaticity characteristic as compared to a liquid crystal panel in which a colored layer of other colors, such as a colored layer of Y, is provided in the unit pixel.

Moreover, the backlight unit 13 is constructed to illuminate the illuminating light on the color filter 12 by using a fluorescent tube. In the backlight unit 13 using the fluorescent tube, since it is not necessary to apply four kinds of fluorescence materials in the fluorescent tube and the backlight unit 13 is constructed by applying three kinds of fluorescence materials (RGB) in the tube, as compared to the case where four kinds of fluorescence materials are applied, the fluorescent tube can be formed in a simple arrangement and the rise in manufacturing cost of the backlight unit 13 can be minimized. Moreover, the color adjustment can easily be performed when designing the color characteristic of the backlight unit 13.

In this way, it is therefore possible to realize a remarkably wide range of color reproduction, and to display an image with display colors in a wide wavelength region which is similar to that of natural light and thus to minimize the rise in manufacturing cost of the backlight unit 13.

In the above-mentioned embodiment, although the description was made to the case where the colored layer in a unit pixel have four color arrangement of BCGR, the colored layer may have four color arrangement of BGYR by replacing C with Y.

Moreover, in the first embodiment as described before, although the description was made to the case where the transmission type liquid crystal panel was used, the color filter 12 having colored layers of four colors in the unit pixel may be provided in the liquid crystal panel of a reflection type or a half-reflection type.

(Second Embodiment)

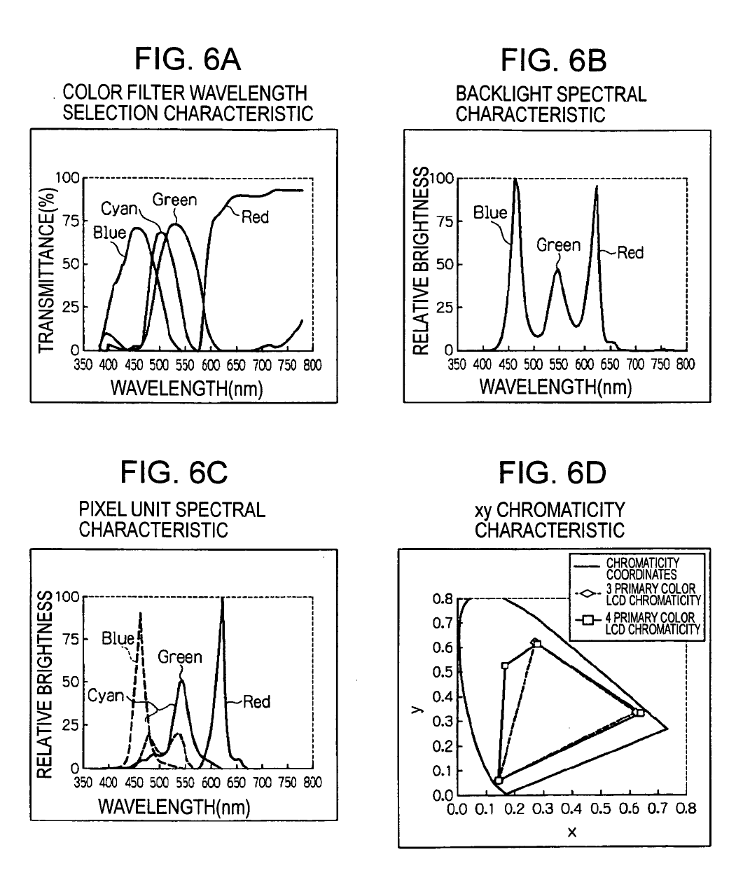

Hereinafter, a second embodiment of the present embodiment will be described with reference to FIG. 6.

The second embodiment is applied to the case where the light source of the backlight unit 13 is changed without changing the arrangement of the colored layer of BCGR and the arrangement in the unit pixel of the color filter 12. Although the first embodiment is applied to the case where a three-wavelength fluorescent tube type backlight unit was used, the second embodiment is applied to the case where a three color LED (solid-state light source) type backlight unit is used.

In the second embodiment, the same elements as the first embodiment will be indicated by the same reference numerals for the simplification of explanation.

FIG. 6 shows a color filter wavelength selection characteristic, a backlight spectral characteristic, a pixel unit spectral characteristic and an xy chromaticity characteristic. Here, the color filter wavelength selection characteristic is the same as that of the first embodiment as described above.

Next, the arrangement of the backlight unit 13 according to the second embodiment will be explained.

The backlight unit 13 is equipped with three color LEDs as a light source. The backlight unit 13 of the first embodiment that uses three-wavelength fluorescent tube contains three dominant peaks and shows a discontinuous portion in the spectral characteristic (refer to FIG. 5(b)). On the other hand, the backlight unit 13 that uses three color LEDs contains three dominant peaks but shows a smooth spectral characteristic as shown in FIG. 6(b). In addition, in the spectral characteristic of the three color LEDs, it is possible to easily adjust the characteristic by adjusting the amount of current in each LED of RGB.

Moreover, as shown in FIG. 6(b), the spectral characteristic of the illuminating light emitted from the backlight unit 13 is distributed in order of B (Blue), G (Green), and R (Red) towards the longer wavelength side from the shorter wavelength side of visible light. In this way, the number of the peak wavelengths in the illuminating light of the backlight unit 13 is three that is fewer than four, that is, the number of the peak wavelengths in the wavelength selection characteristic of the color filter 12.

Furthermore, in the spectral characteristic (refer to (b) in Table 1) of the illuminating light in the backlight unit 13, the peak wavelengths in the characteristic are located in three regions of 400 to 490 nm, 490 to 570 nm and 600 nm or more. Moreover, the wavelength selection characteristic (refer to (a) in Table 1) of the color filter 12 is located in four regions of 400 to 490 nm, 490 to 520 nm, 520 to 570 nm, and 600 nm or more.

Here, the 400 to 490 nm region and 600 nm or more regions correspond to wavelengths that show B and R respectively and to the shorter wavelength side of visible light and the longer wavelength side of visible light. In the 400 to 490 nm region and the 600 nm or more regions, the spectral characteristic of the illuminating light of the backlight unit 13 and the characteristic and the wavelength selection characteristic of a colored layer match each other.

Furthermore, in the wavelength selection characteristic of a colored layer, the 490 to 520 nm region and the 520 to 570 nm region serve as wavelengths that show C and G. Moreover, in the spectral characteristic of the illuminating light of the backlight unit 13, the 490 to 570 nm region serves as wavelength that shows the color of G. Thus, C and G of a colored layer are displayed by the light of the wavelength that shows G contained in illuminating light.

Moreover, the 520 to 570 nm region (G) in the wavelength selection characteristic of the colored layer and the 490 to 570 nm region (G) in the spectral characteristic of illuminating light are set such that they may be in agreement in general. Moreover, as for the 490 to 520 nm region (C) in the wavelength selection characteristic of the colored layer, this region (C) is not need to be made in agreement with the peak wavelength of the spectral characteristic of illuminating light.

The image display system 1 having such arrangement, the image data inputted into the input sensor 2A is outputted to the liquid crystal panel 3F through the control circuit 2B and 3B, the signal processing circuits 2D and 3D, and the encoding circuit 2E, the decoding circuit 3A, and the drive circuit 3E.

Specifically, in the liquid crystal panel 3F, the illuminating light of the backlight unit 13 illuminates a colored layer of four colors of the color filter 12. Here, the wavelengths according to the spectral characteristic mentioned above are contained in the illuminating light. Moreover, the colored layer transmits the colors of the wavelengths according to the above-mentioned wavelength selection characteristic. Moreover, the liquid crystal layer 11 controls the quantity of lights transmitted through the color filter 12. By this construction, an image is displayed with four primary colors of BCGR of the colored layer in the unit pixel as shown in FIG. 6(c). Further, since the quantity of lights that transmit each colored layer is controlled by the liquid crystal layer 11, the lights that transmitted each of the colored layers are composed and therefore it is possible to achieve a full color image display.

Here, since the spectral characteristic of the backlight unit that uses three color LEDs shows a smooth characteristic as shown in FIG. 6(b), the spectral characteristic of a pixel unit shows a smooth distribution as shown in FIG. 6(c).

Next, with reference to FIG. 6(c), a xy chromaticity characteristic in which the liquid crystal panel having the colored layer of four colors (4CF) in a unit pixel as mentioned above is compared to the liquid crystal panel having the colored layer of three colors (3CF) of RGB will be described. Although it is possible to realize the color of the triangle region in xy chromaticity characteristic with the pixel arrangement of three color colored layer, it is possible to realize the color of the quadrangle region in xy chromaticity characteristic with the pixel arrangement of four color colored layer. Therefore, the liquid crystal panel 3F of the second embodiment having the pixel arrangement of the colored layer of four colors are able to realize wide color range.

As mentioned above, in the second embodiment, the number of the colored layers which constitute the unit pixel of the color filter 12 is made to be greater than the number of peaks at different wavelength regions of spectral characteristic that are in the illuminating light. That is, the number of colored layers in the unit pixel is four, the number of peaks at different wavelength regions in the spectral characteristic is three.

As a result, by providing four colored layers in the unit pixel, it is possible to realize a remarkably wide range of color reproduction and to display an image with display colors in a wide wavelength region which is similar to that of natural light. In addition to realizing a wide color range, it is possible to make the number of peaks at different wavelength regions in the illuminating light fewer than the number of the colored layers in the unit pixel, thereby making it possible to simplify the components in the backlight unit 13. Furthermore, the color characteristic design of the backlight unit 13 can be easily adjusted as a result of having the simplified components in the backlight unit 13.

Moreover, since the peak wavelengths in the wavelength selection characteristic of R and B in the colored layers correspond to the peak wavelengths of the spectral characteristics of R and B contained in illuminating light, the illuminating light which has the wavelengths of R and B is not absorbed or attenuated in the colored layers, and thus it is possible to display R and B with a clear coloring.

Moreover, with this arrangement, the wavelength selection characteristic of C and G in the colored layers and the spectral characteristic of G in the illuminating light will be located within the wavelength regions of R and B. G and C are colors of comparatively high visual-sensitivity as compared to R or B. Since the wavelength of R and B can be displayed with a clear coloring, it is possible to perform a full color image display with a clear coloring by coloring four colors of the colored layers as a whole.

Moreover, since the peak wavelengths of the illuminating light are located in three regions of 400 to 490 nm, 490 to 570 nm, and 600 nm or more in accordance with the spectral characteristic, and the colored layers in the unit pixel have the wavelength selection characteristic which consists of four regions of 400 to 490 nm, 490 to 520 nm, 520 to 570 nm, and 600 nm or more, the peak wavelengths in the spectral characteristic correspond to the wavelength selection characteristic of the colored layer, and it is possible to display R and B with a clear coloring.

In addition, since the peak wavelengths of the illuminating light correspond to the wavelength selection characteristic of the colored layer, specifically in the wavelength regions of 490 to 520 nm and 520 to 570 nm in the wavelength selection characteristic of the colored layer and the 490 to 570 nm wavelength region in the spectral characteristic of the illuminating light, it is possible to display G and C with a clear coloring. Therefore, it is possible to display each colors of R, G, B, and C with a clear coloring and thus to perform a full color image display with a clear coloring.

Moreover, since four colored layers in a unit pixel correspond to R, G, B, and C, it is possible to realize a remarkably wide range of color reproduction and thus to realize display colors in a wide wavelength region which is similar to that of natural light.

To explain in detail, since in xy chromaticity characteristic, the region defined by the left or the upper left side of the line connecting the coordinates of B and G is larger than the region defined by the upper right side of the line connecting the coordinates of G and R and the region defined by the lower right side of the line connecting the coordinates of R and B, the region defined by the left or the upper left side of the line connecting the coordinates of B and G is a region where the possibility for expressing colors close to natural light is greater. Here, since the colored layer having a coordinate located at the region defined by the left or the upper left side of the line connecting the coordinates of B and G, that is the colored layer of C, is provided in the unit pixel, it is possible to widen the color reproduction range in the above-mentioned greater possibility region. Therefore, it is possible to realize a remarkably wide range of color and thus to realize display colors in a wide wavelength region which is similar to that of natural light.

Further, the liquid crystal panel 3F in which the colored layers of four colors containing C is provided in the unit pixel can widen the range of a region that can be displayed in the xy chromaticity characteristic as compared to a liquid crystal panel in which a colored layer of other colors, such as a colored layer of Y, is provided in the unit pixel.

Furthermore, since the backlight unit 13 which uses three color LEDs is used in the second embodiment, it is not necessary to apply four kinds of LEDs that emits four colors respectively. Thus, as compared to the case where four kinds of LEDs are applied, it is possible to make a simple arrangement and to minimize rise in manufacturing cost of the backlight unit 13. Moreover, the color adjustment can be easily performed when designing the color characteristic of the backlight unit 13.

In this way, it is therefore possible to realize a remarkably wide range of color reproduction, and to display an image with display colors in a wide wavelength region which is similar to that of natural light and thus to minimize the rise in manufacturing cost of the backlight unit 13.

In addition, the spectral characteristic of the backlight unit 13 using LED shows a smoother distribution as compared to that of the case where the fluorescent tube is used in the illumination unit. By this, the spectral characteristic of the transmitted light which have transmitted the colored layer of the color filter 12 shows a smooth distribution as well and it is therefore possible to display an image with the smoothly distributed spectral characteristic as mentioned above.

Moreover, in the backlight unit 13 using LEDs, it is possible to easily adjust the color characteristic design as compared to the backlight unit 13 using the fluorescent tube.

Specifically, in order to use the fluorescent tube as the backlight unit 13, it is necessary to manufacture a fluorescent tube by applying a fluorescence material corresponding to the luminescence color onto the tube and to check whether or not the illuminating light having a desired spectral characteristic is obtained, and to use the fluorescent tube as the backlight unit 13. Therefore, after the fluorescent tube has been manufactured, it is not possible to adjust the spectral characteristic of the fluorescent tube.

On the other hand, in case of using LEDs as the backlight unit 13, since it is checked whether or not the illuminating light having a desired spectral characteristic is obtained while adjusting the amounts of current supplied to the LEDs of RGB corresponding to the spectral characteristic of the illuminating light, and the LEDs are used for the backlight unit 13, it is possible to arbitrarily adjust the spectral characteristic.

Therefore, in the backlight unit using the LEDs, it is possible to easily adjust the color characteristic design as compared to the backlight unit 13 using the fluorescent tube.

In addition, in the second embodiment as described before, although the description was made to the case where LED was used for the solid-state light source, it is not limited to the LED. For example, the solid-state light source having spontaneous light emitting devices, such as OLED (organic electroluminescence device) and FED (field emitting device) may also be used.

(Electronic Apparatus)

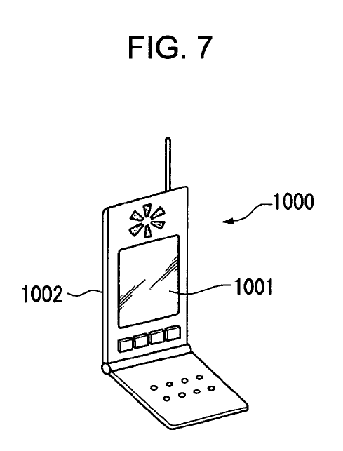

FIG. 7 shows an electronic apparatus embodiment according to the present invention.

The electronic apparatus of this example is equipped with the image display system mentioned above.

FIG. 7 is a perspective view showing an exemplary cellular phone. In FIG. 7(a), a reference number 1000 indicates the body part of the cellular phone; a reference number 1001 indicates the display unit using the liquid crystal panel 3F mentioned above; and a reference number 1002 indicates the side where CCD camera using the input sensor 2A is formed.

Since the electronic apparatus shown in FIG. 7 is equipped with the liquid crystal panel 3F of the embodiments mentioned above at the display unit, it is possible to display an image with display colors in a wide wavelength region which is similar to that of natural light and further to provide an electronic apparatus at a low cost.

Although preferred embodiments of the present invention have been described with a reference to appended drawings, it is needless to say that the present invention is limited to those embodiments. A number of changes, modifications, or alterations to the invention as described herein may be made, none of which depart from the spirit of the present invention. All such changes, modifications and alterations should therefore be seen as within the scope of the present invention.

1. A display device comprising:
a color filter unit which has a plurality of colored layers in a unit pixel, in which the plurality of colored layers corresponds to a plurality of wavelength regions each with a different wavelength selection characteristic;
an illumination unit for illuminating light onto the color filter unit, in which the illuminating light has a spectral characteristic with peaks at a plurality of wavelength regions; and
a transmitted light quantity control unit for controlling the quantity of light transmitted to the color filter unit,
wherein the number of colored layers in the unit pixel is greater than the number of peaks at different wavelength regions in the illuminating light illuminated by the illumination unit, and image display is performed with the number of primary colors corresponding to the number of colored layers.

2. The display device according to claim 1,
wherein the number of colored layers in the unit pixel is four, the number of peaks at different wavelength regions in the illuminating light illuminated by the illumination unit is three, and image display is performed with four primary colors.

3. The display device according to claim 1,
wherein two peak wavelengths in the wavelength selection characteristic of the two colored layers correspond to the two peak wavelengths in the spectral characteristic of the illuminating light, respectively.

4. The display device according to claim 3,
wherein the two peak wavelengths are peak wavelengths which are respectively located at the longer wavelength side and the shorter wavelength side in a visible light wavelength region.

5. The display device according to claim 1,
wherein the peak wavelengths of the illuminating light are located in three regions of 400 to 490 nm, 490 to 570 nm, and 600 nm or more in accordance with the spectral characteristic, and
wherein the colored layer in the unit pixel has the wavelength selection characteristic which includes four regions of 400 to 490 nm, 490 to 520 nm, 520 to 570 nm, and 600 nm or more.

6. The display device according to claim 1,
wherein the illumination unit illuminates the illuminating light onto the color filter using a fluorescent tube.

7. The display device according to claim 1,
wherein the illumination unit illuminates the illuminating light onto the color filter using a solid-state light source.

8. An electronic apparatus having the display device according to claim 1.
